(19) United States
(12) Patent Application Publication
(10) Pub. No.: US 2020/0410187 A1
(43) Pub. Date: Dec. 31, 2020

(54) IMAGE PROCESSING METHOD AND IMAGE PROCESSING APPARATUS

(71) Applicant: SEIKO EPSON CORPORATION, Tokyo (JP)

(72) Inventors: Masaya USUI, Shiojiri (JP); Atsushi GOTO, Matsumoto (JP)

(21) Appl. No.: 16/912,854

(22) Filed: Jun. 26, 2020

(30) Foreign Application Priority Data
Jun. 28, 2019 (JP) 2019-121693

(51) Int. Cl. G06K 7/14

(52) U.S. Cl. CPC G06K 7/1452; G06K 7/146

(57) ABSTRACT

An image processing method including a detection step for detecting an end of a code element constituting a code image included in an input image, a transfer step for transferring first data constituting one end in a width direction of the code element to, as second data, a position, in the code element, at an inner side from the one end in the width direction, and a gray-scale value conversion step for converting a gray-scale value of the first data to shorten a length in the width direction of the code element.

The present application is based on, and claims priority from JP Application Serial Number 2019-121693, filed Jun. 28, 2019, the disclosure of which is hereby incorporated by reference herein in its entirety.

### BACKGROUND

### 1. Technical Field

The present disclosure relates to an image processing method and an image processing apparatus.

### 2. Related Art

An ink jet printing apparatus is disclosed, which is configured to delete at least one line of pixels from an end on one side of a code image in order to suppress thickening of bar due to ink bleed-through when printing the code image representing a code such as a barcode, or a two-dimensional code represented by a QR code (trade name) (see JP-A-2015-66833).

Each of the elements such as a bar constituting a bar code may have halftone color at its end. The term halftone indicates a color between black color, which is the color of the element, and white or a background color, which is the color of the gap between the elements. Alternatively, in the course of image processing for printing images, the pixel number of the images may be converted, resulting in the occurrence of the halftone at the end of the element.

When a deletion of the one line of pixels is performed in an image including the element of which the end is halftone as described in JP-A-2015-66833, there are cases where the halftone at the end of the element is vanished, resulting in, in the print result, a variation in the ratio of the widths between the elements. The variation in the ratio of the widths between the elements degrades the quality of the code.

### SUMMARY

An image processing method includes a detection step for detecting an end of a code element constituting a code image included in an input image, a transfer step for transferring first data constituting one end in a width direction of the code element to, as second data, a position, in the code element, at an inner side from the one end in the width direction, and a gray-scale value conversion step for converting a gray-scale value of the first data to shorten a length in the width direction of the code element.

### BRIEF DESCRIPTION OF THE DRAWINGS

FIG. 1 is a block diagram illustrating a configuration of an image processing apparatus in a simplified manner.

FIG. 2 is a flowchart illustrating an image processing.

FIG. 3 is an explanatory diagram illustrating a flow of an image processing in accordance with a specific example.

FIG. 4 is an explanatory diagram illustrating a flow of a pixel processing when a transfer step is not included.

FIG. 5 is a flowchart illustrating an image processing of a first modification example.

FIG. 6 is an explanatory diagram illustrating, in accordance with a specific example, a flow of an image processing of a second modification example.

### DESCRIPTION OF EXEMPLARY EMBODIMENTS

Hereinafter, an embodiment of the present disclosure will be described with reference to the accompanying drawings. Note that each of the drawings is merely an exemplification for describing the embodiment. Each of the drawings is an exemplification, which may not be consistent with each other, or may be partially omitted.

1. Apparatus Configuration:

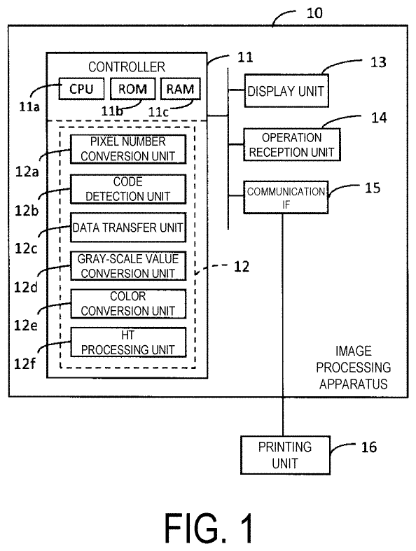

FIG. 1 illustrates a configuration of an image processing apparatus 10 according to the embodiment in a simplified manner.

The image processing apparatus 10 is configured to perform an image processing method. The image processing apparatus 10 includes a controller 11, a display unit 13, an operation reception unit 14, a communication interface 15, and the like. The term interface is abbreviated as IF. The controller 11 is configured to include one or a plurality of ICs including a CPU 11a as a processor, a ROM lib, a RAM 11c, and the like, and other components such as a non-volatile memory.

In the controller 11, the processor, that is, the CPU 11a performs arithmetic processing according to a program stored in the ROM 11b and other components such as a memory, using the RAM 11c and the like as a work area, to control the image processing apparatus 10. The controller 11, in accordance with an image processing program 12, functions as a pixel number conversion unit 12a, a code detection unit 12b, a data transfer unit 12c, a gray-scale value conversion unit 12d, a color conversion unit 12e, and an HT processing unit 12f, and the like. The abbreviation HT stands for half tone. Note that the processor is not limited to a single CPU, and may be configured to perform processing with a hardware circuit such as a plurality of CPUs or an ASIC, or a may be configured to perform processing by a CPU and hardware circuits cooperating to each other.

The display unit 13, which is a means for displaying visual information, is configured, for example, by a liquid crystal display, an organic EL display, or the like. The display unit 13 may be configured to include a display and a driving circuit for driving the display. The operation reception unit 14 is a means for receiving an operation by the user, where the means is achieved by, for example, a physical button, a touch panel, a computer mouse, a keyboard, or the like. It goes without saying that the touch panel may be achieved as one function of the display unit 13.

The display unit 13 and the operation reception unit 14 may be a part of the configuration of the image processing apparatus 10, and may be a peripheral device equipped externally to the image processing apparatus 10 as well. The communication IF 15 is a generic term for one or a plurality of the IFs for the image processing apparatus 10 to perform wired or wireless communication with the outside in accordance with a prescribed communication protocol including a publicly known communication standard.

A printing unit 16 is an external device to which the image processing apparatus 10 couples via the communication IF 15. That is, the printing unit 16 is a printing apparatus controlled by the image processing apparatus 10. The printing apparatus is also referred to as printer, recording device, or the like. The printing unit 16 performs printing on a print medium by an ink jet scheme based on the print data sent from the image processing apparatus 10. The printing unit 16 is configured to discharge ink having a plurality of colors such as cyan (C), magenta (M), yellow (Y), and black (K), for example, to perform printing. The print medium is typically a paper, but may be a medium of material other than the paper. According to the ink jet scheme, the printing unit 16 discharges dots of ink from non-illustrated nozzles based on the print data to perform printing on the print medium.

The image processing apparatus 10 is achieved by, for example, a personal computer, a smartphone, a tablet terminal, a mobile phone, or an information processing apparatus having approximately the same degree of processing capability as those components. The image processing apparatus 10 may also be achieved by an independent, a single information processing apparatus, as well as by a plurality of information processing apparatuses communicatively coupled to each other via a network.

The configuration including the image processing apparatus 10 and the printing unit 16 can be regarded as a system. Alternatively, the image processing apparatus 10 and the printing unit 16 may be an integrated device. That is, a configuration may also be employed in which one printing apparatus includes the image processing apparatus 10 and the printing unit 16. The printing apparatus including the image processing apparatus 10 and the printing unit 16 may be a multifunctional machine that combines a plurality of functions such as a copying function, a facsimile function, and the like.

2. Image Processing Method:

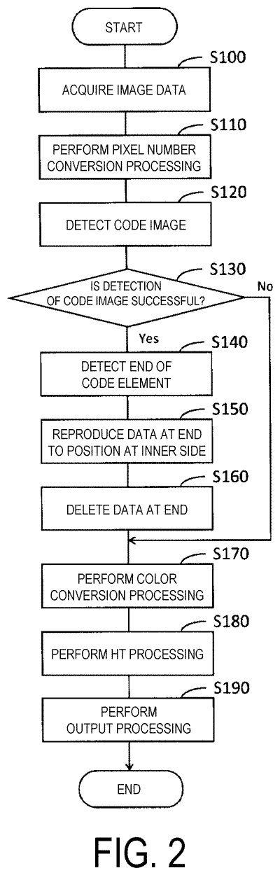

FIG. 2 illustrates, by a flowchart, an image processing of the embodiment that the controller 11 performs in accordance with the image processing program 12.

In step S100, the controller 11 acquires image data that are to be processed. The controller 11 acquires the image data from a storage source of the image data in response to a selection command of the image data from the user via the operation reception unit 14, for example. There are various storage sources of the image data, such as a memory within the image processing apparatus 10, a hard disk drive, or an external memory, a server, and the like that are accessible by the controller 11, for example. The image data acquired in step S100 is an input image.

The image data are bitmap data having a gray-scale value for each of RGB (Red, Green, and Blue) for each of the pixels, for example. The gray-scale value is represented by 256 gradations from 0 to 255, for example. It goes without saying that the controller 11 appropriately converts the format of the image data to acquire the bitmap data of RGB that are to be processed.

In step S110, the pixel number conversion unit 12a performs pixel number conversion processing on the image data where necessary. The pixel number conversion includes a processing in which the resolution of each of the horizontal and vertical aspects of the image data is caused to match the print resolution, by the printing unit 16, of each of the horizontal and vertical aspects. The print resolution is already determined at the time of step S110 by the product specification of the printing unit 16 and a setting related to printing that is pre-input by the user via the operation reception unit 14. For example, supposing that the resolution of each of the horizontal and vertical aspects of the image data is 600 dpi and the print resolution of each of the horizontal and vertical aspects of the image data is 720 dpi, the pixel number of each of the horizontal and vertical aspects of the image data is caused to increase by 1.2 times. The unit dpi represents the pixel number per inch. The pixel number conversion may not be substantially performed due to the magnification ratio of the pixel number conversion becoming 1.0 depending on the relationship between the image data and the print resolution.

In step S120, the code detection unit 12b detects a code image from the image data. In the embodiment, “code” or “code image”, which refers to one type of pattern image in which information is encoded, indicates a barcode, a QR code (trade name), or other two-dimensional codes. Various methods can be used as the method of detecting the code image, including publicly known methods. For example, the code detection unit 12b can detect, as a barcode, a pattern image in which black bars are arranged in a direction intersecting the length direction of the bars by a predetermined number or more within the image data.

In step S130, the code detection unit 12b branches the subsequent processing depending on whether the code image is successfully detected in step S120. When the code detection unit 12b has successfully detected one or more code images from the image data in step S120, proceeds the processing from the determination of “Yes” in step S130 to step S140. On the other hand, when the code image is failed to be detected from the image data in step S120, the code detection unit 12b proceeds the processing from the determination of “No” in step S130 to step S170. Hereinafter, descriptions will be continuously given on the premise that the code image has been successfully detected from the image data.

In step S140, the code detection unit 12b detects the end of the code element constituting the code image detected in step S120. The step S140 corresponds to a detection step for detecting the end of the code element. The code element constituting the code image indicates, for example, an individual bar constituting a barcode, provided that the code image is a barcode.

The end of the code element indicates a position at which switching is performed from a gap color, which is the color of the gap between the code elements, to a color being darker than the gap color. The end is also referred to as edge. The gap color is, in most cases, a white color. The code detection unit 12b performs scanning, in a predetermined direction, of the color of each of the pixels in a region corresponding to the code image within the image data and performs searching for the change in the color to detect the end of the code element. The code detection unit 12b may use a predetermined threshold value for distinguishing from the gap color in detecting the end of the code element.

In step S150, the data transfer unit 12c transfers the first data, which is the end of the code element detected in step S140 and constitutes one end in the width direction of the code element to, as second data, a position, in the code element, at the inner side from the one end in the width direction. The step S150 corresponds to a transfer step.

In step S160, the gray-scale value conversion unit 12d deletes the first data constituting the one end. The term deletion herein referred to does not indicate a reduction of the amount of data, but indicates a processing in which the first data are converted into a color, that is, the gap color that does not indicate the code element, to thus shorten the length in the width direction of the code element. The step S160 corresponds to a gray-scale value conversion step for converting a gray-scale value of the first data to shorten the length in the width direction of the code element. The step S160 is a processing for suppressing thickening of the code element due to ink bleed-through.

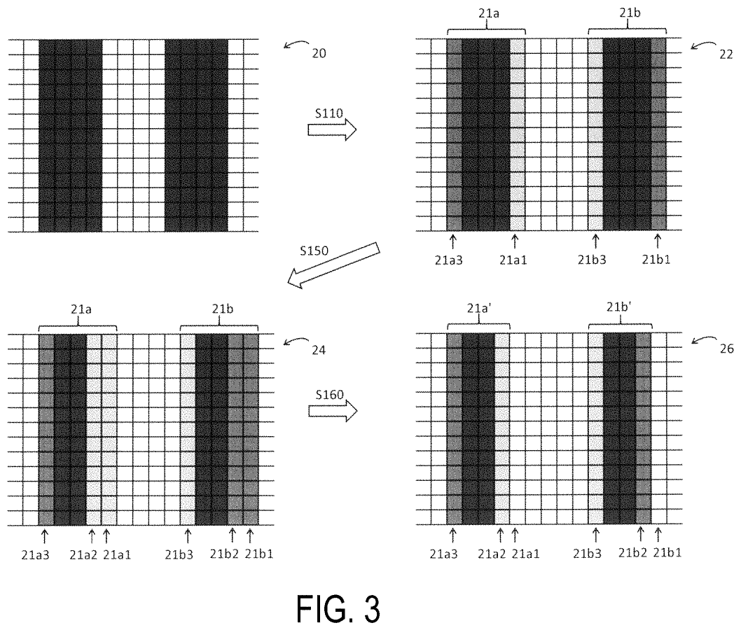

FIG. 3 is an explanatory diagram for illustrating the flow of pixel processing in accordance with a specific example. In FIG. 3, the reference sign 20 denotes a part of the image region within the image data. Each of the rectangles constituting an image region 20 is each of the pixels. Note that the image region 20 corresponds to a part of the barcode as a code image included in the image data. In the image region 20, a bar as code element is represented by a plurality of aggregations of black pixels. In addition, an aggregation of pixels having a color that is not black color in the image region 20 represents a gap between the bars.

In step S110, the pixel number conversion unit 12a performs pixel number conversion processing on the image data to convert the image region 20 into an image region 22. In the example of FIG. 3, the pixel number conversion processing causes the pixel number of the image data in the horizontal direction to increase. A processing of causing the pixel number to increase is an interpolation of pixels. Various interpolation methods for pixels are known. The pixel number conversion unit 12a, when the magnification ratio of the pixel number conversion is not an integer, uses, for example, a bilinear method as an interpolation method that is useful for suppressing image quality degradation.

An interpolation method for generating interpolated pixels with reference to a plurality of peripheral pixels, such as bilinear method is prone to cause pixels of halftone to occur. The term halftone indicates a color between the color of the code element and the gap color, where, provided that the color of the code element is black color and the gap color is a white color, the term halftone indicates a gray color. Further, even when the term halftone merely indicates the grey color, the interpolated pixels, which are to be generated, are various such as relatively dark gray color and relatively light gray color. An interpolated pixel of halftone basically occurs at the end of the code element.

The step S120 is performed on the image data including the image region 22 to detect a code image. As described above, because the image region 20 represents one portion of a barcode, a peripheral region including the image region 22 is detected as a code image. Hereinafter, for convenience, the image region 22 is referred to as a code image 22. The reference signs 21a and 21b denote each of the bars that constitute the code image 22, that is, each of the code elements. In step S140, the code detection unit 12b detects the end of each of such code elements 21a and 21b.

The reference sign 21a1 denotes a pixel row corresponding to one end in the width direction of the code element 21a, and the reference sign 21a3 denotes a pixel row corresponding to the other end in the width direction of the code element 21a. The width direction of the code element indicates the lateral direction of a bar, provided that the code element is a bar of bar code. In the example of FIG. 3, the pixel row is formed by pixels that are continuous in the longitudinal direction of a bar. Similarly, the reference sign 21b1 denotes a pixel row corresponding to one end in the width direction of the code element 21b, and the reference sign 21b3 denotes a pixel row corresponding to the other end in the width direction of the code element 21b. In the description referring to FIG. 3, the right of the right and left of the code element is one in the width direction of the code element, and the left is the other in the width direction, and these relationships may be reversed.

In the example of FIG. 3, in the code image 22, each of pixel rows 21a1 and 21a3 as the ends of the code element 21a and each of pixel rows 21b1 and 21b3 as the ends of the code element 21b are halftone. Further, in the example of FIG. 3, the pixel row 21a1 of the code element 21a is halftone being lighter in color than the pixel row 21a3, and the pixel row 21b1 of the code element 21b is halftone being darker in color than the pixel row 21b3.

As a result of step S150 on the code image 22 by the data transfer unit 12c, the pixel row 21a1 of the code element 21a is reproduced to the position, in the code element 21a, of a pixel row 21a2 at the inner side from the pixel row 21al. That is, in step S150, in the code element 21a, the pixel row 21a1, which is one end in the width direction are the same as the data of the pixel row 21a2 at the inner side from the pixel row 21a1. The pixel row 21a1 corresponds to one example of the first data, and the pixel row 21a2 on which the processing in step S150 is performed corresponds to one example of the second data. Similarly, the pixel row 21b1 of the code element 21b is reproduced to the position, in the code element 21b, of a pixel row 21b2 at the inner side from the pixel row 21b1. That is, in step S150, the pixel row 21b1, which is one end in the width direction, are the same data as the pixel row 21b2 at the inner side from the pixel row 21b1 in the code element 21b. The pixel row 21b1 corresponds to one example of the first data, and the pixel row 21b2 on which the processing in step S150 is performed corresponds to one example of the second data. The code image 22 on which the processing in step S150 is performed as such is referred to as a code image 24.

As a result of step S160 on the code image 24 by the gray-scale value conversion unit 12d, the color of each of the pixels in the pixel row 21a1, which is one end in the width direction of the code element 21a, is uniformly converted into the gap color. Similarly, the color of each of the pixels in the pixel row 21b1, which is one end in the width direction of the code element 21b, is uniformly converted into the gap color. The gray-scale value conversion unit 12d employs a white color as the gap color. The white color is represented by R=G=B=255. Alternatively, when the actual gap color is a color different from the white color in the code image 24, the gray-scale value conversion unit 12d may convert the color of each of the pixels in the pixel row 21a1 of the code element 21a and the color of each of the pixels in the pixel row 21b1 of the code element 21b into a gray-scale value representing the actual gap color, that is, the background color of the code element. In step S160, the widths of the code elements 21a and 21b are substantially narrowed. The code elements 21a and 21b having widths narrowed in step S160 are referred to as code elements 21a′ and 21b′. Further, the code image 24 on which the processing in step S160 is performed as such is referred to as a code image 26.

After step S160 or after the determination of “No” in step S130, the color conversion unit 12e performs color conversion processing on the image data at that time (step S170). In step S170 after being processed in step S170, the color conversion processing is naturally performed on the image data including the code image that has been subjected to the processing in steps S140 to S160. The color conversion processing, which is a processing in which the coloring system of image data is converted into the ink coloring system used by the printing unit 16 for performing printing, is performed on each of the pixels. The coloring system of the image data is RGB as described above, for example, and the ink coloring system is CMYK as described above, for example. The color conversion processing is performed with reference to a color conversion look-up table that prescribes the conversion relationships of these coloring systems.

In step S180, the HT processing unit 12f performs HT processing on the image data on which the color conversion is performed. The HT processing is, in outline, a processing in which the gray-scale value for each of the pixels of the image data and for each of ink colors CMYK are binarized into information indicating discharge of ink (dot ON) or non-discharge of ink (dot OFF). The HT processing is performed by, for example, dithering method or error diffusion method.

In step S190, the controller 11 outputs the image data after performing HT processing to the printing unit 16 as printed data. In the output processing of step 190, the image data after performing HT processing are appropriately permutated in accordance with the timing and the order that are used by the printing unit 16, and are then output to the printing unit 16. Such an output processing is also referred to as rasterization processing. As a result, the printing unit 16 performs printing based on the print data that is output from the image processing apparatus 10.

### 3. Summary

As such, the image processing method according to the embodiment includes the detection step for detecting the end of the code element constituting the code image included in the input image, a transfer step for transferring the first data constituting the one end in the width direction of the code element to, as the second data, a position, in the code element, at the inner side from the one end in the width direction, and a gray-scale value conversion step for converting the gray-scale value of the first data to shorten the length in the width direction of the code element.

According to the above method, even if the first data as the end of the code element constituting the code image is halftone, the halftone is held, as the second data, at the inner side from the end in the transfer step, and then the first data are processed in the gray-scale value conversion step to narrow the width of the code element. This allows, as a result of the printing of the input image including the code image, the variation in the ratio of the widths between the code elements to be suppressed, and a print result in which thickening of the code element due to ink bleed-through is suppressed, to be obtained.

In the above-described embodiment, the transfer step of step S150 exemplifies an example in which the first data are reproduced and arranged as the second data. However, in addition to this, the transfer step of step S150 may be, for example, a processing in which the first data, on which a slight data change is performed such as adding a correction value to the first data, are arranged as the second data. Further, the transferring of third data, which will be described later, may not be a processing of pure reproduction but a processing in which the third data, on which a slight data change is performed such as adding a correction value to the third data, are arranged as fourth data.

Note that the gray-scale value conversion step of step S160 is a processing of converting a gray-scale value of the first data into a gray-scale value representing a white color. Alternatively, the gray-scale value conversion step of step S160 may be a processing of converting the gray-scale value of the first data into a gray-scale value representing the background color of the code element.

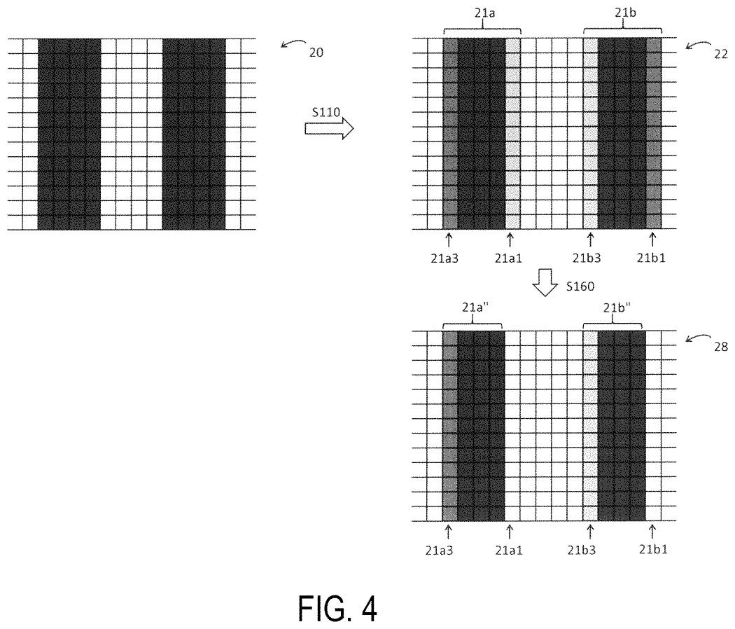

The advantageous effects achieved by the embodiment are further described by comparing FIG. 3 with FIG. 4.

FIG. 4 is an explanatory diagram illustrating, in accordance with a specific example, the flow of the pixel processing when the transfer step of step S150 is not included. The description of the image region 20 and the image region 22 (the code image 22) after performing conversion of the pixel number of the image region 20 is common in FIGS. 3 and 4. When the transfer step is not performed, the pixel row 21a1 and the pixel row 21b1, which are one ends in the width direction, are simply deleted, in the code elements 21a and 21b, in order to suppress thickening of the code element due to ink bleed-through. FIG. 4 illustrates, as the code image 22, a state where one end in the width direction is deleted for the code elements 21a and 21b in the code image 22, that is, a state where the gray-scale value conversion step of step S160 is performed. In FIG. 4, the code elements 21a and 21b having widths narrowed in step S160 are referred to as code elements 21a″ and 21b″.

The pixel of halftone has dot ON or dot OFF by HT processing in accordance with the shade of color in unit of pixel. However, each of the code elements having halftone at both ends in the width direction in a state before performing HT processing, in which each of the pixels has dot ON or dot OFF at each of both ends in the width direction, is likely to hold, when seen from the entirety of the code elements, the ratio of the mutual widths of the code elements in the print result. For example, the code elements 21a and 21b, each of which is constituted, in the code image 22, by the pixel row×1 in dark gray color, the pixel rows×3 in black color, and the pixel row×1 in light gray color, can have a ratio of approximately 1:1 of the mutual widths. Even in a state where the code elements 21a′ and 21b′ are turned into the code elements 21a′ and 21b′, the halftone is held at both ends of the width due to the advantageous effects of the transfer step, thus the ratio of the width is approximately 1:1 even in the print result that has undergone HT processing. As such, the variation in the ratio of the widths between the code elements is suppressed to maintain the quality of a code such as a barcode.

On the other hand, as in the code image 28 illustrated in FIG. 4, in a state where the halftone of one end in the width direction of the code element 21a vanishes and the halftone of one end in the width direction of the code element 21b vanishes due to the influence of the gray-scale value conversion step of step S160, the ratio of the widths between the code elements is liable to vary in the print result that has undergone HT processing. In the example of the code image 28, in the code element 21a″, the pixel row at the other end in the width direction is in dark gray color and the remaining three pixel rows are in black color, and in the code element 21b″, the pixel row at the other end in the width direction is in light gray color and the remaining three pixel rows are in black color. In such code elements 21a″ and 21b″ that have undergone HT processing, the code element 21b″ is more thinly printed in whole than the code element 21a″, resulting in a variation in the ratio of the mutual widths of code elements 21a″ and 21b″.

### 4. Modification Example

Next, several modification examples included in the embodiment will be described.

### First Modification Example

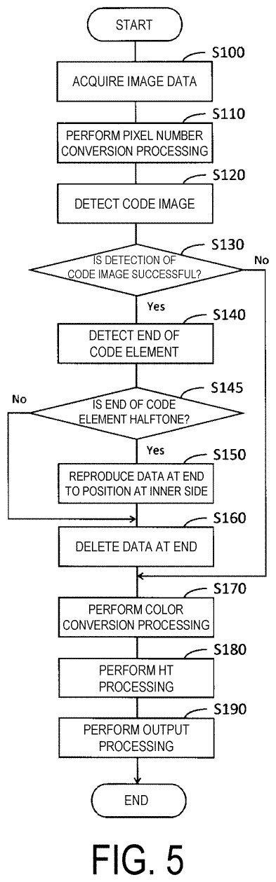

FIG. 5 illustrates, by a flowchart, image processing according to a first modification example that the controller 11 performs in accordance with an image processing program 12. The flowchart of FIG. 5 differs from the flowchart of FIG. 2 in that the former includes the determination of step S145. After performing step S140, the controller 11 determines whether the end of the code element detected in step S140 corresponds to halftone (step S145). The step S145 corresponds to a determination step. The end detected in step S14.0 obviously has a color being darker than the gap color. Accordingly, the controller 11 can determine that the end of the code element corresponds to halftone when the color of any one of the pixels that constitute the end of the code element is a color being lighter than the color at the inner side from the end in the code element.

The controller 11, when the end of the code element corresponds to halftone, determines as “Yes” in step S145 and proceeds to step S150. On the other hand, the controller 11, when the end of the code element does not correspond to halftone, determines as “No” in step S145 and proceeds to step S160. Supposing that the magnification ratio of the pixel number conversion in the pixel number conversion processing in step S110 is an integer such as 2.0, for example, halftone does not basically occur at the end of the code element within the image data after performing pixel number conversion.

As such, according to the first modification example, the image processing method includes a determination step for determining whether the end of the code element corresponds to halftone. Then, when it is determined in the determination step that the end of the code element corresponds to halftone, the transfer step of step S150 and the gray-scale value conversion step of step S160 are performed, while when it is determined that the end of the code element does not correspond to halftone, the gray-scale value conversion step of step S160 is performed without performing the transfer step of step S150. Thus, when the code element does not have halftone color at its end, the transfer step for holding the halftone of the end of the code element can be omitted to reduce the burden required for the image processing.

Note that when the code element does not have halftone color but black color at its end, even if step S150 is performed, there is no change in the color at the position at the inner side from the end of the code element. Thus, the processing result obtained by performing steps S150 and S160 when the code element does not have halftone color but black color at its end is the same as the processing result obtained by omitting step S150 and performing step S160 when the color of the code element is not halftone but black color at its end.

### Second Modification Example

In the transfer step of step S150, the third data constituting the other end in the width direction of the code element may be further transferred as the fourth data to a position, in the code element, at the inner side from the other end in the width direction, and in the gray-scale value conversion step of step S160, the gray-scale value of the third data may be further converted to shorten the length in the width direction of the code element.

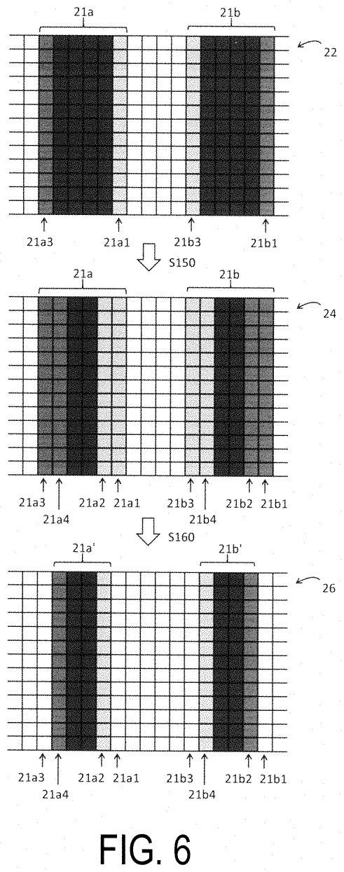

FIG. 6 is an explanatory diagram illustrating, in accordance with a specific example, the flow of image processing according to the second modification example. FIG. 6 illustrates the image region 22 (the code image 22), as in FIG. 3. In step S150, the data transfer unit 12c reproduces the pixel row 21a1 of the code element 21a to the position, in the code element 21a, of the pixel row 21a2 at the inner side from the pixel row 21a1, and reproduces the pixel row 21a3 of the code element 21a to the position, in the code element 21a, of a pixel row 21a4 at the inner side from the pixel row 21a3. Similarly, the data transfer unit 12c reproduces the pixel row 21b1 of the code element 21b to the position, in the code element 21b, of the pixel row 21b2 at the inner side from the pixel row 21b1, and reproduces the pixel row 21b3 of the code element 21b to the position, in the code element 21b, of a pixel row 21b4 at the inner side from the pixel row 21b3. The pixel row 21a3 corresponds to one example of the third data, and the pixel row 21a4 on which the processing in step S150 is performed corresponds to one example of the fourth data. Similarly, the pixel row 21b3 corresponds to one example of the third data, and the pixel row 21b4 on which the processing in step S150 is performed corresponds to one example of the fourth data.

In step S160, the gray-scale value conversion unit 12d uniformly converts the color of each of the pixels in the pixel row 21a1 of the code element 21a into the gap color, and uniformly converts the color of each of the pixels in the pixel row 21a3 of the code element 21a into the gap color. Similarly, the gray-scale value conversion unit 12d uniformly converts the color of each of the pixels in the pixel row 21b1 of the code element 21b into the gap color, and uniformly converts the color of each of the pixels in the pixel row 21b3 of the code element 21b into the gap color. In step S160, the widths of the code elements 21a and 21b are narrowed by two pixel rows. The controller 11 applies the second modification example to a code element including, for example, a pixel row having a width not less than a predetermined number. This makes it possible to suitably suppress the thickening due to ink bleed-through of the code element having relatively large thickness.

### Other Descriptions

The halftone at the end of the code element occasionally occurs from the start, in addition to the occurrence of the halftone due to pixel interpolation as a pixel number conversion processing. Here, the term “from the start” indicates “already at the time when the image data are acquired in step S100”. That is, the image data acquired by the controller 11 in step S100 as a target of image processing may include a code image including a code element having halftone color at its end.

The code image may be a two-dimensional code such as a QR code (trade name). When the code image is the two-dimensional code, in the transfer step of step S150, one end in the height direction orthogonal to the width direction (for example, the lowermost end) of the code element is transferred to a position, in the code element, at the inner side from the lowermost end, in addition to transferring one end in the width direction (for example, the rightmost end) of the code element to a position, in the code element, at the inner side from the rightmost end. Then, when the code image is the two-dimensional code, in the gray-scale value conversion step of step S160, the color at the one end in the width direction of the code element is converted into the gap color, and the color at the one end in the height direction of the code element is converted into the gap color.

What is claimed is:

1. An image processing method comprising:
a detection step for detecting an end of a code element constituting a code image included in an input image;
a transfer step for transferring first data constituting one end in a width direction of the code element to, as second data, a position, in the code element, at an inner side from the one end in the width direction; and
a gray-scale value conversion step for converting a gray-scale value of the first data to shorten a length in the width direction of the code element.

2. The image processing method according to claim 1, wherein
the gray-scale value conversion step is a processing of converting the gray-scale value of the first data into a gray-scale value representing a white color.

3. The image processing method according to claim 1, wherein
the gray-scale value conversion step is a processing of converting the gray-scale value of the first data into a gray-scale value representing a background color of the code element.

4. The image processing method according to claim 1, comprising:
a determination step for determining whether an end of the code element corresponds to halftone being lighter than a color at the inner side from the end of the code element, wherein,
when it is determined, in the determination step, that the end of the code element corresponds to the halftone, the transfer step and the gray-scale value conversion step are performed, while
when it is determined, in the determination step, that the end of the code element does not correspond to the halftone, the gray-scale value conversion step is performed without performing the transfer step.

5. The image processing method according to claim 1, wherein
in the transfer step, third data constituting another end in the width direction of the code element is further transferred as fourth data to a position, in the code element, at an inner side from the other end in the width direction, and
in the gray-scale value conversion step, a gray-scale value of the third data is further converted to shorten a length in the width direction of the code element.

6. An image processing apparatus comprising:
a detection unit configured to detect an end of a code element constituting a code image included in an input image;
a data transfer unit configured to transfer first data constituting one end in a width direction of the code element to, as second data, a position, in the code element, at an inner side from the one end in the width direction; and
a gray-scale value conversion unit configured to convert a gray-scale value of the first data to shorten a length in the width direction of the code element.
